(19) United States
(12) Patent Application Publication
(10) Pub. No.: US 2008/0074861 A1
(43) Pub. Date: Mar. 27, 2008

(54) INDICATOR DEVICE OF A COMPUTER FRONT PANEL

(75) Inventors: YUN-LUNG CHEN, Tu-Cheng (TW); Ming-Xian Sun, Shenzhen (CN); Shi-Zhong Zhou, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,779

(22) Filed: Sep. 23, 2006

(51) Int. Cl. G01D 11/28

(52) U.S. Cl. 362/23

(57) ABSTRACT

An indicator device includes a lamp and a light conduct post seat. The lamp includes a body for radiating light and a flange. The light conduct post seat includes a light conduct post formed on one side of the light conduct post seat, and a plurality of hooks formed on an opposite side of the light conduct post seat corresponding to the light conduct post. The flange of the lamp is clasped by the plurality of hooks to secure the lamp onto the light conduct post seat with the body of the lamp being received in a space surrounded by the plurality of hooks and a distal end of the body being aligned with the light conduct post.

### 1. FIELD OF THE INVENTION

The present invention relates to indicator devices, and more particularly to an indicator device for indicating computer operating state.

### 2. DESCRIPTION OF RELATED ART

A plurality of indicator devices are mounted on a front panel of a computer enclosure for indicating different running states of the computer. These indicator devices can be used to show power on/off of the power supply, writing/reading operation of hard disk drives, idle state, and so on.

In a typical computer enclosure, the indicator devices are light emitting diode (LED) indicators which are mounted on a panel directly. For example, a device for retaining an LED indicator on a computer enclosure includes a hole defined in a panel of the enclosure for receiving the LED indicator therein. The hole has a circumferential edge along which a perpendicular flange is formed for surface contacting and thus securely retaining the LED indicator. Two radially extending slits are defined in the panel in communication with the hole thereby forming a resilient tab therebetween. A nominal diameter of the hole is substantially corresponding to or slightly smaller than a diameter of the LED indicator whereby when the LED indicator is inserted into the hole, the resilient tab is deflected and thus applies a biasing force to the LED indicator for securely retaining the LED indicator. However, because the LED indicator is fragile, it is easy to damage the LED indicator when the LED indicator is inserted into the hole.

It is therefore desirable to find a new indicator device which is mounted on the front panel without damage.

### SUMMARY OF THE INVENTION

An indicator device includes a lamp and a light conduct post seat. The lamp includes a body for radiating light and a flange. The light conduct post seat includes a light conduct post formed on one side of the light conduct post seat, and a plurality of hooks formed on an opposite side of the light conduct post seat corresponding to the light conduct post. The flange of the lamp is clasped by the plurality of hooks to secure the lamp onto the light conduct post seat with the body of the lamp being received in a space surrounded by the plurality of hooks and a distal end of the body being aligned with the light conduct post.

Other advantages and novel features will be drawn from the following detailed description of preferred embodiments with attached drawings, in which:

### BRIEF DESCRIPTION OF THE DRAWINGS

FIG. 1 is an exploded isometric view of a front panel, and an indicator device in accordance with a preferred embodiment of the present invention including a light conduct post seat and two lamps;

FIG. 2 is an assembled isometric view of the indicator device of FIG. 1;

FIG. 3 is an isometric view of the indicator device of FIG. 1 mounted on the front panel of FIG. 1; and

FIG. 4 is an isometric view of an indicator device in accordance with another embodiment of the present invention.

### DETAILED DESCRIPTION OF THE INVENTION

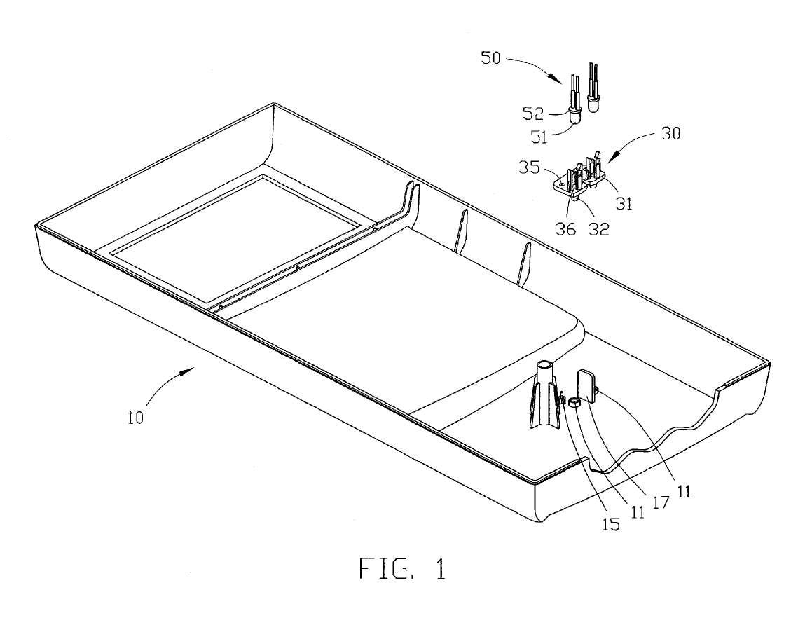

Referring to FIG. 1, an indicator device in accordance with a first embodiment of the present invention is used to be mounted on a front panel 10 of a computer enclosure for indicating different operating states of a computer system. The indicator device includes a light conduct post seat 30 and two lamps 50. The two lamps 50 radiate different colored lights, for example one radiating red colored light and the other radiating green colored light. In the present embodiment, the lamp 50 is an LED which includes a cylindrical body 51, and a circumferential flange 52 formed on one end of the body 51. A cross section of the flange 52 is larger than a cross section of the body 51.

The front panel 10 forms a light-shielding piece 17 on an inner surface of the front panel for shielding lights radiated by the two lamps 50 from each other. A pair of through holes 11 is defined in the front panel 10 respectively located on opposite sides of the light-shielding piece 17. The front panel 10 forms a pair of securing pins 15 adjacent the pair of through holes 11 respectively. The securing pin 15 is made of fusible plastic.

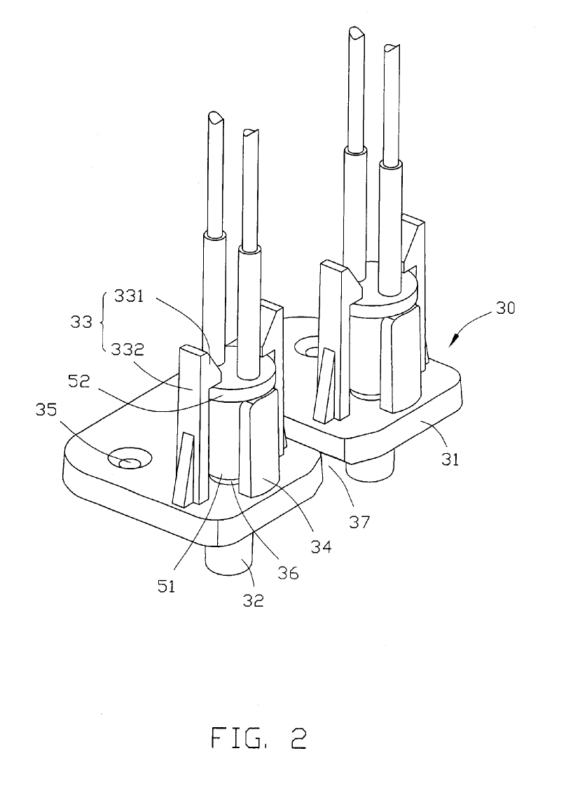

Referring to FIGS. 1 and 2, the light conduct post seat 30 includes a base 31. A cutout 37 is defined in a center portion of the base 31 corresponding to the light-shielding piece 17. Two light conduct posts 32 extend from bottom surface of the base 31, and are formed respectively beside opposite edges of the cutout 37. Two recesses 36 are defined on a top surface of the base 31 respectively corresponding to each of the two light conduct posts 32. The recess 36 is sunk toward the corresponding light conduct post 32 for light to conveniently transmit through the base 31 into the corresponding light conduct post 32. A pair of hooks 33 is formed on opposite sides of the recess 36 respectively, and a pair of stop pieces 34 is formed on another opposite sides of the recess 36 respectively. Each of the pair of hooks 33 includes a shank 332 and a barb 331 protruded from a top of the shank 332. A bottom of the barb 331 is higher than a top of the stop piece 34, and a distance between them in a vertical direction is slightly less than a thickness of the flange 52 of the lamp 50. A length of the stop piece 34 is approximately equal to a length of the body 51 of the lamp 50. The base 31 also defines a pair of securing holes 35 corresponding to the pair of securing pins 15.

In assembly of the lamp 50 onto the light conduct post seat 30, the pair of hooks 33 is bent outwards. The body 51 and the flange 52 of the lamp 50 are located between the pair of hooks 33 until a bottom of the flange 52 contacts the tops of the pair of stop pieces 34. Then, the pair of hooks 33 is relaxed to an original position and the barbs 331 of the hooks 33 clasp a top of the flange 52, so the lamp 50 is secured on the light conduct post seat 30 by reason of the flange 52 being clamped between the barbs 331 of the hooks 33 and the stop pieces 34. Now, a distal end of the body 51 of the lamp 50 is aligned with the recess 36. Because the lengths of the stop pieces 34 are equal to the length of the body 51 of the lamp 50, the distal end of the body 51 is close enough to the recess 36, and the body 51 doesn't resist the light conduct post seat 30 because of the recess 36. The other lamp 50 is mounted on the light conduct post seat 30 following the same process described above.

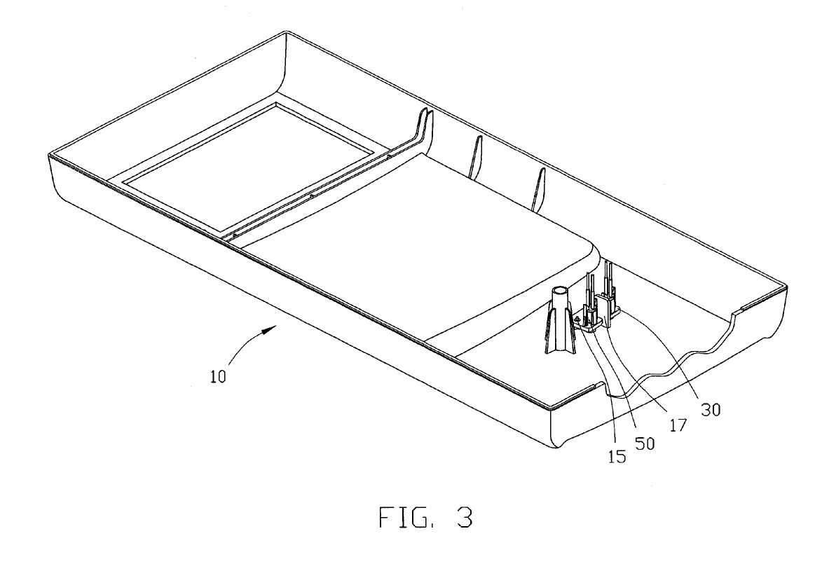

Referring to FIGS. 1 to 3, in assembly of the light conduct post seat 30 with two lamps 50 to the front panel 10, the light conduct post seat 30 is moved towards the front panel 10. The light-shielding piece 17 of the front panel 10 passes through the cutout 37 of the light post seat 30 to be positioned between the two lamps 50, the securing pins 15 of the front panel 10 extend through the securing holes 35 of the light conduct post seat 30, and the light conduct posts 32 of the light conduct post seat 30 pass through the through holes 11 to be exposed on an outer surface of the front panel 10 simultaneously. Then, portions of the securing pins 15 that pass through the securing holes 35 are fused to secure the light conduct post seat 30 on the front panel 10. Because the light-shielding piece 17 is located between the two lamps 50, light radiated by one lamp 50 of the two lamps 50 doesn't interfere with the light radiated by the other of the two lamps 50.

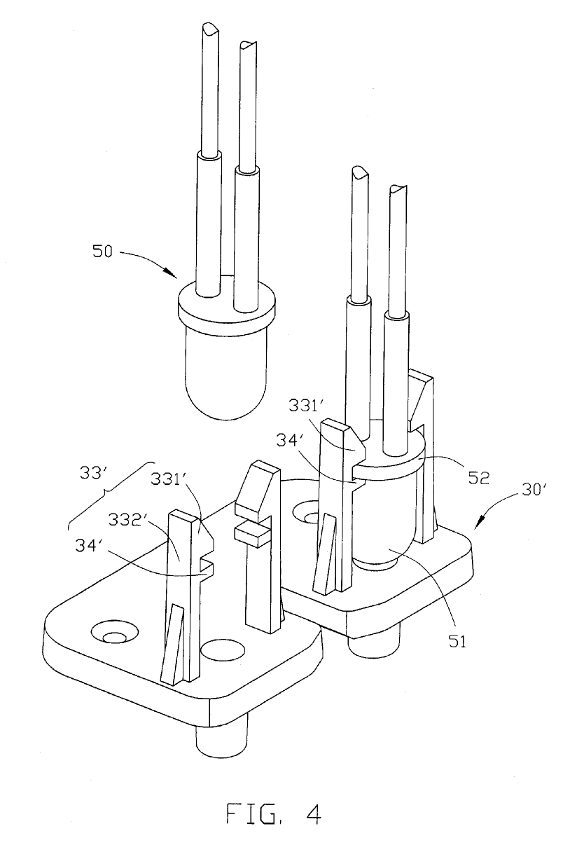

Referring to FIG. 4, a second embodiment of the indicator device is shown. The second embodiment is generally similar to the first embodiment except that the second embodiment has different structures for securing the lamps 50 on the light conduct post seat as that of the first embodiment. In the second embodiment, the stop pieces 34 of the first embodiment are omitted, and hooks 33′ in the second embodiment are different from the hooks 33 in the first embodiment. The hooks 33′ each include a shank 332′. A barb 331′ and a stop piece 34′ are protruded from the shank 332′, and aligned in a vertical direction with the barb 331′ being located above the stop piece 34′. A distance between a top of the stop piece 34′ and a bottom of the barb 331′ is slightly smaller than the thickness of the flange 52 of the lamp 50.

In assembly the lamp 50 to the light conduct post seat 30′, the stop pieces 34′ of the hooks 33′ resist against the bottom of the flange 52 of the lamp 50, and the barbs 331′ of the hooks 33′ clasp the top of the flange 52. The flange 52 is firmly clamped between the barbs 331′ and the hooks 33′ to secure the lamp 50 on the light conduct post seat 30′.

In the above two embodiments, the light conduct post seats 30, 30′ can be secured on the front panel 10 by other means, such as by screws, and so on.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

1-16. (canceled)

17. An indicator device comprising:
a lamp comprising a body for radiating light and a flange; and
a light conduct post seat comprising a base secured to one inside of a panel which defines a through hole, at least one securing pin formed on the inside of the panel, at least one securing hole defined in the base, the at least one securing pin inserted in the at least one securing hole to secure the base on the inside of the panel, a light conduct post extending from one side of the base into the through hole, and a retaining structure extending from an opposite side of the base and configured for securing the lamp on the light conduct post seat with a distal end of the body aligning with the light conduct post and a gap being formed between the distal end of the body and the base.

18. The indicator device as described in claim 17, wherein the base defines a recess on said opposite side of the base In alignment with the light conduct post, the recess sunk towards the light conduct post for the light being conveniently transmitted into the light conduct post.

19. The indicator device as described in claim 18, wherein the retaining structure comprises a pair of barbs and a pair of stop pieces lower than the barbs in a direction perpendicular to the base, the flange of the lamp being clamped between the barbs and the stop pieces.

20. The indicator device as described in claim 18, further comprising another lamp secured on said opposite side of the base, another light conduct post extending from said one side of the base corresponding to said another lamp, a cutout defined in the base between the two lamps, and a light-shielding piece formed on the inside of the panel to be inserted in the cutout to be positioned between the two lamps and the two light conduct posts for shielding light radiated by the two lamps from each other.

21. The indicator device as described in claim 17, wherein the at least one securing pin is made of fusible plastic.

22. An indicator device comprising:
a lamp comprising a body for emitting light and a flange;
a panel having a through hole defined therein; and
a light conduct post seat comprising a base plate, a light conduct post and a retaining structure, the base plate having a first surface brought into contact with the panel, an opposite second surface, and a recess defined in the second surface, the light conduct post protruding from the first surface of the base plate and extending through the through hole of the panel, the retaining structure formed on the second surface of the base plate with the lamp being retained therein and located outside of the base plate and above the second surface, the lamp being oriented in a manner that the body thereof faces toward the second surface and is aligned with the light conduct post for emitting the light into the light conduct post through the recess, a gap being formed between a distal end of the body and the base plate.

23. The indicator device as described in claim 22, wherein at least one securing pin formed on the inside of the panel, at least one securing hole defined in the base, the at least one securing pin inserted in the at least one securing hole to secure the base on the inside of the panel.
